(19) United States
(12) Patent Application Publication
(10) Pub. No.: US 2026/0253884 A1
(43) Pub. Date: Aug. 27, 2026

(54) SILICON-CARBON COMPOSITE NEGATIVE ELECTRODE MATERIAL AND METHOD OF PREPARING SAME

(71) Applicant: CBBS, Co., Ltd., Daegu (KR)

(72) Inventors: Chan Byon, Ulsan (KR); Youngdae Seo, Gyeongju-si (KR)

(73) Assignee: CBBS, Co., Ltd., Daegu (KR)

(21) Appl. No.: 19/543,839

(22) Filed: Feb. 18, 2026

(30) Foreign Application Priority Data
Feb. 24, 2025 (KR) 10-2025-0023793

(51) Int. Cl. H01M 4/38; H01M 4/36; H01M 4/583; H01M 4/62; H01M 10/42

(52) U.S. Cl. CPC H01M 4/386; H01M 4/366; H01M 4/583; H01M 4/622; H01M 4/625; H01M 10/4235

(57) ABSTRACT

Proposed is a method of preparing a silicon-carbon composite negative electrode material, the method including the following steps of preparing a first spray solution by adding a binder polymer and nano-silicon to a mixed solvent including two or more organic solvents and stirring the resulting mixture, spraying the first spray solution and performing first drying to obtain spherical powders having a hollow structure in which nano-silicon particles are agglomerated, preparing a second spray solution by stirring the spherical powders with a commercially available carbon source, spraying the second spray solution and performing second drying to obtain a spherical powder composite having a hollow structure, and performing heat treatment on the spherical powder composite in an inert atmosphere.

### CROSS REFERENCE TO RELATED APPLICATION

The present application claims priority to Korean Patent Application No. 10-2025-0023793, filed Feb. 24, 2025, the entire contents of which is incorporated herein for all purposes by this reference.

### ACKNOWLEDGEMENT

This invention was made with the support of the Ministry of Trade, Industry and Energy (MOTIE) of the Republic of Korea under Project No. RS-2024-00508085, which was conducted by YC Advanced Co., Ltd. in the research project titled ‘Development of polyimide binder for anodes of high capacity and high stability secondary batteries.

### BACKGROUND

The present disclosure relates to a silicon-carbon composite negative electrode material and a method of preparing the same.

Secondary batteries are eco-friendly energy storage devices and serve as an essential technology in various industries, including electric vehicles (EVs), energy storage systems (ESSs), and portable electronic devices. Graphite, primarily used as a negative electrode material for commercially available secondary batteries, is classified into natural graphite and artificial graphite. However, graphite has limitations in meeting the demand for high-capacity batteries due to its structural characteristics and low theoretical capacity (372 mAh/g). Especially during long-term use, natural graphite exhibits low structural stability due to volume expansion, and artificial graphite requires complex manufacturing processes such as high-temperature heat treatment leading to high costs, which is disadvantageous. Accordingly, there is a pressing need to develop next-generation negative electrode materials that can replace graphite.

Silicon has a theoretical capacity of 4200 mAh/g or higher and is attracting attention as a next-generation negative electrode material that can provide storage capacity 10 times or more than that of graphite. In particular, silicon has high energy density and fast charge and discharge characteristics and is expected to play a key role in markets where large-capacity lithium secondary batteries are required.

Accordingly, the silicon negative electrode material market is showing rapid growth and is projected to account for approximately 10.1% of the entire negative electrode material market by 2027. Additionally, the market size is expected to reach 20 trillion KRW or more by 2030, and silicon negative electrode materials are evaluated as having a high potential to replace conventional graphite-based negative electrode materials.

However, silicon negative electrode materials repeatedly undergo volume expansion by approximately 300% or more during charging and discharging. As a result, high mechanical stress is generated, leading to problems such as cracking of the particles, collapse of the electrode structure, detachment from a current collector, and blockage of charge transport pathways.

Due to these problems, the commercialization of silicon negative electrode materials has been delayed, and various technological approaches have been pursued to address such issues.

First, one approach involves reducing the size of silicon particles to a nanometer level, thereby reducing mechanical stress resulting from volume expansion. It has been reported that silicon particles of approximately 150 nm or less exhibit low mechanical stress and thus less frequently result in cracking during charging and discharging. However, industry experts point out that cracking is still highly likely to occur as the number of cycles increases. Additionally, when preparing nano-silicon, environmental problems may arise due to the use of toxic substances such as silane (SiH₄).

Furthermore, another approach involves forming a composite of silicon with silica (SiO₂) or a graphite-based carbon material, thereby suppressing volume expansion. Silica exhibits high chemical and mechanical stability, but requires high-temperature vacuum processes to form such composites, and the effect thereof on capacity increase is limited due to a low silicon content. Silica is also problematic because irreversible reactions occur with electrolytes, resulting in reduced initial efficiency. On the other hand, carbon-silicon composites, despite having high initial efficiency, lack structural robustness and thus exhibit low cycle life stability, which is disadvantageous.

Additionally, a further approach involves developing carbon composite-based silicon negative electrode materials. Technologies for forming composites of silicon with various commercially available carbon sources (such as graphite, expanded graphite, graphene, carbon nanotubes (CNTs), fullerenes, and carbon black) have been investigated. However, studies on selecting an optimal carbon material are still ongoing, and there remains a need to develop an optimized composite e structure capable of effectively suppressing the volume expansion of silicon.

Currently, the use of silicon negative electrode materials involves adding silicon at a weight ratio of less than 10% to conventional graphite negative electrode materials, and it remains challenging to increase the silicon content due to the issue regarding the significant volume expansion of silicon. Accordingly, for the practical application of silicon-based negative electrode materials, there is a need to develop technologies capable of increasing the silicon content used, improving initial capacity, and simultaneously enhancing cycle efficiency and initial efficiency.

### DOCUMENT OF RELATED ART

### Patent Document

(Patent Document 1) Korean Patent Application Publication No. 10-2023-0152932

### SUMMARY

The present disclosure, which has been devised to address the issues described above, aims to provide a silicon-carbon composite negative electrode material capable of exhibiting high cycle efficiency by suppressing the cracking of spherical silicon particles under low mechanical stress during volume expansion. Additionally, the present disclosure aims to provide a silicon-carbon composite negative electrode material enabling fast charging by forming a uniform conductive network and optimizing electron transport pathways during charging and discharging. Furthermore, the present disclosure aims to provide a stable silicon-carbon composite negative electrode material with high sphericity and uniformity, and a method of preparing the same.

A method of preparing a silicon-carbon composite negative electrode material according to the present disclosure for achieving the objectives as described above includes the following steps: preparing a first spray solution by adding a binder polymer and nano-silicon to a mixed solvent including two or more organic solvents and stirring the resulting mixture; spraying the first spray solution and performing first drying to obtain spherical powders having a hollow structure in which nano-silicon particles are agglomerated; preparing a second spray solution by stirring the spherical powders with a commercially available carbon source; spraying the second spray solution and performing second drying to obtain a spherical powder composite having a hollow structure; and performing heat treatment on the spherical powder composite in an inert atmosphere.

Additionally, the step of preparing the first spray solution includes the following steps: preparing the mixed solvent including two or more organic solvents; adding the nano-silicon to the mixed solvent and performing first stirring; and adding the binder polymer after first the stirring and performing second stirring.

Additionally, the mixed solvent includes: a first organic solvent including one or more of N-methyl-2-pyrrolidone (NMP), dimethyl sulfoxide (DMSO), dimethylformamide (DMF), and tetrahydrofuran (THF); and a second organic solvent including one or more of ethanol, methanol, and acetic acid.

Additionally, the mixed solvent includes: the first organic solvent having a first boiling point; and the second organic solvent having a second boiling point lower than the first boiling point.

Additionally, the first and second organic solvents in the mixed solvent are characterized by being mixed at a mass ratio in the range of 10:1 to 2:1.

Additionally, the binder polymer is characterized by being present in an amount in the range of 1 to 5 parts by weight with respect to 100 parts by weight of the mixed solvent.

Additionally, the nano-silicon is characterized by being present in an amount in the range of 1 to 7 parts by weight with respect to 100 parts by weight of the mixed solvent.

Additionally, the nano-silicon is characterized by having a size in the range of 0.1 to 0.7 μm.

Additionally, the commercially available carbon source includes one or more of natural graphite, artificial graphite, carbon black, acetylene black, graphite intercalated compounds (GICs), expanded graphite, activated carbon, graphite nanoplatelets (GNPs), and carbon nanotubes (CNTs).

Additionally, the commercially available carbon source is an aqueous carbon solution including one or more carbon materials, 100 parts by weight of the aqueous carbon solution contain 0.5 to 1.5 parts by weight of the one or more carbon materials, and the spherical powders are characterized by being present in an amount in the range of 4 to 6 parts by weight with respect to 100 parts by weight of the aqueous carbon solution.

Additionally, the heat treatment is characterized by being performed at a temperature in the range of 600° C. to 800° C. in an inert atmosphere for 2 to 4 hours.

As described above, the present disclosure can provide a silicon-carbon composite negative electrode material and a method of preparing the same. The silicon-carbon composite negative electrode material can suppress the cracking of spherical silicon particles under low mechanical stress during volume expansion, thereby exhibiting high cycle efficiency. Additionally, the silicon-carbon composite negative electrode material enables fast charging by forming a uniform conductive network and optimizing electron transport pathways during charging and discharging. As a result, a stable silicon-carbon composite negative electrode material with high sphericity and uniformity can be prepared. However, the scope of the present disclosure is not limited by the foregoing effects.

### BRIEF DESCRIPTION OF THE DRAWINGS

FIG. 1 is a flowchart describing a method of preparing a silicon-carbon composite negative electrode material according to a preferred embodiment of the present disclosure;

FIG. 2 is an enlarged diagram showing spherical powders in a method of preparing a silicon-carbon composite negative electrode material according to a preferred embodiment of the present disclosure;

FIG. 3 is a diagram showing hollow structures of spherical powders in a method of preparing a silicon-carbon composite negative electrode material according to a preferred embodiment of the present disclosure; and

FIG. 4 is a diagram silicon-carbon composite negative electrode material prepared by a method of preparing a silicon-carbon composite negative electrode material according to a preferred embodiment of the present disclosure.

### DETAILED DESCRIPTION

The advantages and characteristics of the present disclosure and methods for achieving those will become clear with reference to the following embodiments described in detail in conjunction with the attached drawings. However, the present disclosure is not limited to the embodiments set forth below and will be implemented in many different forms. The following embodiments are provided only to completely disclose the present disclosure and inform those skilled in the art to which the present disclosure pertains of the scope of the present disclosure. The present disclosure is defined only by the scope of the appended claims. Like reference numerals are used throughout the specification to indicate like components.

In the following embodiments, terms such as first and second are not used in a restrictive sense but are used to distinguish one component from another.

In the following embodiments, the singular expressions are intended to include the plural forms unless the context clearly indicates otherwise.

In the following embodiments, it will be further understood that the terms “comprise”, “include”, “have”, and the like specify the presence of stated features or components described herein, but do not preclude the possibility of the addition of one or more other features or components.

In the following embodiments, when a layer, region, component, or the like is described as being disposed on or above another layer, region, component, or the like, this includes not only the case where the layer, region, component, or the like is disposed directly on the other layer, region, component, or the like, but also the case where one or more other intervening layers, regions, components, or the like is interposed therebetween.

In the drawings, for convenience of description, the sizes of components may be exaggerated or reduced. For example, the sizes and thicknesses of the respective components shown in the drawings are arbitrarily illustrated for convenience of description. Therefore, the present disclosure is not necessarily limited to those illustrated.

As used herein, the term “A and/or B” means A, B, or both A and B. Additionally, the term “at least one of A and B” means A, B, or both A and B.

In the following embodiments, when layers, regions, components, or the like are described as being connected, this includes cases where the layers, regions, components, or the like are directly connected, and/or cases where the layers, regions, components, or the like are connected indirectly with one or more other layers, regions, components, or the like interposed therebetween. For example, as used herein, when layers, regions, components, or the like are described as being electrically connected, this refers to cases in which the layers, regions, components, or the like are directly electrically connected and/or cases in which the layers, regions, components, or the like are electrically connected indirectly with one or more other layers, regions, components, or the like interposed therebetween.

When an amount, concentration, other value, or parameter is given herein as a range, preferred range, or enumeration of preferred upper values and preferred lower values, it should be understood to specifically disclose all ranges that can be formed by pairing any upper range limit or a preferred value with any lower range limit or a preferred value, regardless of whether such ranges are separately disclosed. When a range of numerical values is described herein, unless otherwise specified, for example, by terms such as “greater than” or “less than”, this range is intended to include the endpoint values and all integers and fractions within the range. The scope of the present disclosure is not intended to be limited to the specific values mentioned when a range is defined.

Among the physical properties described herein, when the measurement temperature affects a particular physical property, unless otherwise specified, this physical property is measured at room temperature. The term “room temperature” refers to a natural temperature, without heating or cooling. For example, room temperature may refer to a temperature within the range of approximately 10° C. to approximately 30° C., such as 23° C. or 25° C. Additionally, unless otherwise specified, the unit of temperature used herein is ° C.

Furthermore, among the physical properties described herein, when the measurement pressure affects a particular physical property, unless otherwise specified, this physical property is measured at atmospheric pressure, that is, ambient pressure (approximately 1 atmosphere).

Hereinafter, the present disclosure will be described with reference to drawings for explaining a method of preparing a silicon-carbon composite negative electrode material according to embodiments of the present disclosure.

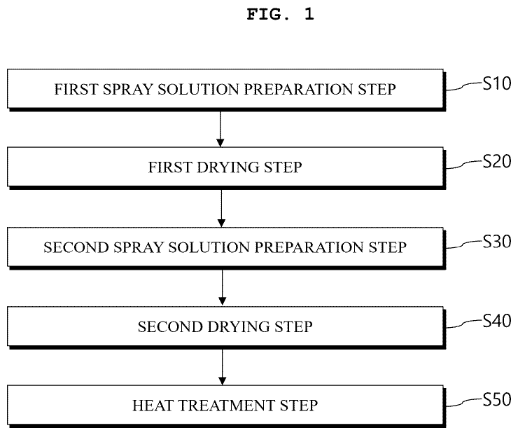

Referring to FIG. 1, the method of preparing the silicon-carbon composite negative electrode material, according to the present disclosure, includes: a first spray solution preparation step (S10), a first drying step (S20), a second spray solution preparation step (S30), a second drying step (S40), and a heat treatment step (S50).

First, in the first spray solution preparation step (S10), a first spray solution may be prepared by adding a binder polymer and nano-silicon to a mixed solvent including two or more organic solvents and stirring the resulting mixture.

In this case, the first spray solution preparation step (S10) may include a mixed solvent preparation step, a first stirring step, and a second stirring step.

In the mixed solvent preparation step, the mixed solvent including two or more organic solvents may be prepared.

In this case, the mixed solvent may include: a first organic solvent including one or more of NMP, DMSO, DMF, and THE; and a second organic solvent including one or more of ethanol, methanol, and acetic acid.

The first organic solvent may be aprotic, and the second organic solvent may be protic. However, the present disclosure is not limited thereto.

In other words, the mixed solvent may be formed by mixing both the first organic solvent, which is an aprotic solvent, and the second organic solvent, which is a protic solvent. When such a mixed solvent system is applied, an effect of enhancing the performance of the silicon-carbon composite negative electrode material may be achieved, because the two types of solvents serve different roles to improve dispersibility and coating uniformity of the electrode active material. An aprotic solvent exhibits low polarity and thus serves to effectively disperse carbon-based materials, while a protic solvent exhibits high polarity and thus assists in the uniform dispersion of hydrophilic materials such as silicon.

The use of these two solvents in combination creates an environment where silicon and carbon can be uniformly distributed, thereby enabling the formation of a more uniform electrode coating layer. As a result, the active material may be distributed uniformly within the electrode, thereby increasing initial charge storage capacity and maintaining structural stability of the electrode even during charging and discharging.

Additionally, the composition of the mixed solvent may be selected in consideration of solubility, volatility, and chemical reactivity. For example, the mixed solvent may include NMP as the first organic solvent and ethanol as the second organic solvent. However, the present disclosure is not limited thereto.

Additionally, the mixed solvent includes two or more organic solvents to facilitate the formation of a hollow structure as the first spray solution is sprayed and then dried in the first drying step (S20), which will be described later.

The hollow structure may be formed during drying using differences in boiling points.

In other words, the mixed solvent preferably includes the first organic solvent having a first boiling point and the second organic solvent having a second boiling point lower than the first boiling point. However, the present disclosure is not limited thereto.

Specifically, the first organic solvent may have relatively high affinity for the solid components (binder polymer and nano-silicon) and a relatively high boiling point. Additionally, the second organic solvent may have relatively low solubility for the solid components and a relatively low boiling point. In other words, the first organic solvent evaporates more slowly than the second organic solvent due to having a higher boiling point, while the second organic solvent evaporates more rapidly than the first organic solvent. More specifically, the first organic solvent, having a higher boiling point, evaporates relatively slowly, thereby assisting in the uniform coating of the active material while spherical powders are dried. In contrast, the second organic solvent, having a lower boiling point, evaporates rapidly, thereby appropriately controlling the viscosity of the spherical powders and inducing the formation of a uniform carbon layer. In other words, when using these two solvents in combination, rapid deformation or cracking during a solvent removal process within an electrode may be prevented from occurring. As a result, an effect of improving the uniformity of the coating layer may be expected.

Additionally, the first and second organic solvents in the mixed solvent may be mixed at a mass ratio in the range of 10:1 to 2:1. In another example, the mass ratio may be 9:1, 8:1, 7:1, 6:1, 5:1, 4:1, or 3:1. However, the present disclosure is not limited thereto.

In this case, when the ratio of the second organic solvent exceeds the range specified above, the hollow structure may not be formed properly as the second organic solvent drastically disappears as a result of rapid evaporation. Excessively rapid drying causes shrinkage inside the particles, thereby preventing the formation of an internally hollow structure, that is, the hollow structure, and increasing the likelihood that dense solid particles are formed.

Additionally, when the ratio of the second organic solvent is lower than the range specified above, the evaporation rate slows down as the amount of the first organic solvent increases, so the first spray solution may not be dried properly. As a result, in the first drying step (S20) to be described later, particles may agglomerate with each other, or spray droplets may be discharged from a nozzle in an insufficiently dried state during spraying, thereby causing nozzle clogging.

Accordingly, by mixing the first and second organic solvents at the mass ratio specified above, the rapid evaporation of the second organic solvent enables the formation of the internally hollow structure. Additionally, the first organic solvent regulates the evaporation rate to achieve uniform spraying and drying.

In the first stirring step, the nano-silicon may be added to the mixed solvent and stirred.

In this case, the nano-silicon may be present in an amount in the range of 1 to 7 parts by weight with respect to 100 parts by weight of the mixed solvent. In another example, the nano-silicon may be present in an amount of 2 parts by weight or more, 3 parts by weight or more, or 4 parts by weight or more, and 6 parts by weight or less, 5 parts by weight or less, or 4 parts by weight or less. However, the present disclosure is not limited thereto.

In this case, when the nano-silicon is present in an amount of less than or equal to the part by weight specified above, the resulting production yield is excessively low, and a spherical powder composite, to be described later, is unlikely to be formed. Additionally, the resulting nano-silicon content after spray drying may decrease, which may reduce the energy density of the final electrode.

Additionally, when the nano-silicon is present in an amount of greater than or equal to the part by weight specified above, the number of nano-silicon particles may increase, resulting non-uniform distribution and agglomeration. Furthermore, during spray drying, the nano-silicon may not be distributed uniformly within the spray droplets, and excessive concentration is likely to cause nozzle clogging.

In other words, when the nano-silicon is included in an amount within the range of parts by weight specified above, with respect to 100 parts by weight of the mixed solvent, uniform spraying of the nano-silicon may be achieved, thereby enabling improved production yield and uniform particle formation.

Additionally, the nano-silicon may have a size in the range of 0.1 to 0.7 μm. In another example, the size of the nano-silicon may be 0.2 μm or more or 0.3 μm or more, and 0.6 μm or less, 0.5 μm or less, or 0.4 μm or less. However, the present disclosure is not limited thereto.

In this case, when the size of the nano-silicon exceeds the range specified above, cracking of the silicon particles may occur due to volume expansion, and the formation of clusters having a stable hollow structure through spray drying is challenging. This is because, as the size of the nano-silicon particles internal stress during increases, expansion increases, thereby causing cracking to occur more readily in a structural sense, which reduces the durability and cycle efficiency of a silicon electrode.

Additionally, the larger the nano-silicon particles, the more challenging the formation of the internally hollow structure. In other words, although a hollow space is formed inside the nano-silicon particles by the evaporation of the mixed solvent during spray drying, it is challenging to form such a hollow space inside evenly when the nano-silicon particles are large.

Additionally, when the size of the nano-silicon is smaller than the range specified above, although the hollow structure is formed during a process in which the mixed solvent evaporates and the interior shrinks, the size of the nano-silicon particles is small, making it challenging to create an internally hollow space. In other words, only simple solid particles may be formed, rather than spherical powders having a hollow structure.

Additionally, the smaller the nano-silicon particles, the higher the surface energy, causing the particles to agglomerate with each other. Accordingly, during spray drying, these particles may be formed not as individual particles but as high-density agglomerated clusters.

Accordingly, by forming nano-silicon within the size range specified above, cracking does not occur during volume expansion. Additionally, spherical powders having a hollow structure can be readily prepared, and the durability and performance of an electrode can be enhanced.

In the second stirring, the binder polymer may be added and stirred after the first stirring step.

In this case, the binder polymer may be present in an amount in the range of 1 to 5 parts by weight with respect to 100 parts by weight of the mixed solvent, which is preferably 3 parts by weight. However, the present disclosure is not limited thereto.

In this case, the binder polymer ensures that the nano-silicon particles are uniformly dispersed and do not agglomerate.

When the binder polymer is present in an amount of 1 part by weight or less, the nano-silicon particles may fail to be sprayed uniformly, so clusters may not be formed properly. In other words, the formation of the hollow structure becomes challenging, and the electrode structure may become non-uniform.

Additionally, when the binder polymer is present in an amount of 5 parts by weight or more, the silicon particles may be excessively surrounded by the binder polymer, thereby reducing electrical conductivity within the electrode material, which may degrade battery performance in terms of charge storage capacity and cycle efficiency.

Accordingly, by including 1 to 5 parts by weight of the binder polymer with respect to 100 parts by weight of the mixed solvent, the nano-silicon may uniformly agglomerate. As a result, the hollow structure of the nano-silicon, as well as clusters, may be formed, and battery performance may be enhanced.

In this case, the binder polymer may, for example, be polyvinylidene fluoride (PVDF), polyvinyl alcohol (PVA), carboxymethyl cellulose (CMC), or a combination of two or more of the foregoing. However, the present disclosure is not limited thereto.

In the first drying step (S20), spherical powders having a hollow structure in which the nano-silicon particles are agglomerated may be obtained by spraying the first spray solution and performing drying.

In this case, the first spray solution may be dried during spray drying, thereby enabling the formation of the hollow structure. In this case, the hollow structure may be formed by the mixed solvent including two or more organic solvents.

In other words, the nano-silicon, the binder polymer, and the first organic solvent having high affinity for the solid components diffuse within the spray droplets of the first spray solution and move toward the shell of the spray droplets. Additionally, the second organic solvent having relatively low affinity for the solid components is located in the core of the spray droplets. In this state, as the spray droplets are dried by the evaporation of the first and second organic solvents, spherical powders having a diameter of several micrometers and having a hollow structure in which nano-silicon particles are agglomerated are formed.

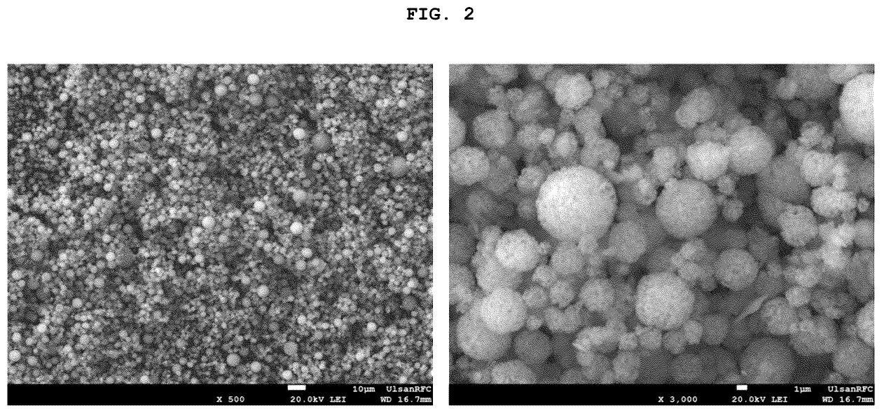

The first and second organic solvents, both of which are organic solvents, have a lower surface tension than water. For this reason, during spray drying, spherical powders having a shape closer to a sphere and a smaller size than those formed from a water-based spray solution are formed, as shown in FIG. 2.

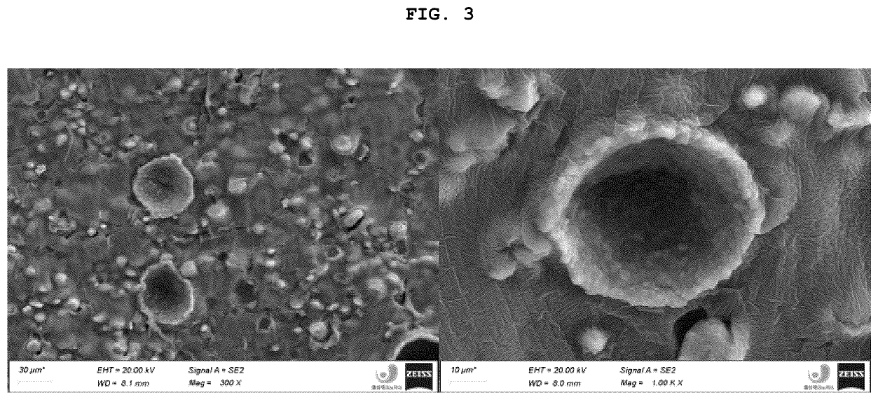

Additionally, the spherical powders are formed into a hollow structure, as shown in FIG. 3. In other words, nano-silicon is formed into spherical powders having a hollow structure due to the evaporation and drying of the organic solvents.

Such spherical powders having a hollow structure contain the binder polymer. As a result, the binder polymer may be carbonized by heat treatment.

In the second spray solution preparation step (S30), a second spray solution may be prepared by stirring the spherical powders and a commercially available carbon source.

In this case, the spherical powders having a hollow structure, formed through the first drying step (S20), maintain their internally hollow structure, as shown in FIG. 3, and serve as a silicon electrode material.

Additionally, carbon coating is required to alleviate the swelling issue of the spherical powders and improve electrical conductivity. In this case, the surface of the spherical powders may be coated uniformly by dispersing a commercially available carbon source.

In other words, in the second spray solution preparation step (S30), the second spray solution, which is sprayable to coat the surface of the spherical powders with the commercially available carbon source, is prepared.

In this case, the commercially available carbon source may include one or more of natural graphite, artificial graphite, carbon black, acetylene black, GICs, expanded graphite, activated carbon, GNPs, and CNTs.

To coat the surface of the spherical powders with the commercially available carbon source, the commercially available carbon source may be made of an aqueous carbon solution including one or more carbon materials.

In this case, 100 parts by weight of the aqueous carbon solution may contain 0.5 to 1.5 parts by weight, preferably 1 part by weight, of one or more carbon materials. However, the present disclosure is not limited thereto.

In this case, when the one or more carbon materials are present in an amount of 0.5 parts by weight or less, such carbon may fail to effectively surround the spherical powders. Accordingly, during charging and discharging, the volume expansion of the spherical powders may fail to be effectively suppressed, thereby causing the spherical particles to crack due to structural instability. Also, the spherical powders exhibit low electrical conductivity. Thus, when there is a lack of carbon, the electrical properties may deteriorate as the conductive pathway between the spherical powders is cut off.

Furthermore, when the one or more carbon materials are present in an amount of 1.5 parts by weight or more, such carbon may not only serve to surround the spherical powders but may also agglomerate itself, thereby forming independent carbon entities. Such carbon entities do not bind to the spherical powders and may act as inactive carbon materials within the electrode, thereby degrading performance. In other words, the uniformity of the silicon-carbon composite negative electrode materials may be reduced, and battery performance may become unstable. Additionally, when an excessive amount of carbon is present, lithium may have difficulty diffusing into the interior of the spherical powders, leading to a decrease in capacity and a reduction in charging and discharging rates. Furthermore, the density of the silicon-carbon composite negative electrode material may decrease, resulting in inefficient utilization of the internal space within the electrode and thereby reducing battery capacity.

Accordingly, 100 parts by weight of the aqueous carbon solution, by containing 0.5 to 1.5 parts by weight of the one or more carbon materials, may surround the spherical powders to prevent cracking of spherical particles, improve conductivity, and facilitate lithium diffusion, thereby enhancing charging and discharging efficiency and durability of a battery.

In the meantime, the spherical powders may be present in an amount in the range of 4 to 6 parts by weight with respect to 100 parts by weight of the aqueous carbon solution, preferably 5 parts by weight. However, the present disclosure is not limited thereto.

Specifically, the spherical powders may be included in an amount in the range of 4 to 6 parts by weight with respect to 100 parts by weight of the aqueous carbon solution.

In this case, when the spherical powders are present in an amount of 4 parts by weight or less, the proportion of the aqueous carbon solution increases. Accordingly, when the second spray solution is sprayed, material distribution within the spray droplets may become unbalanced. In other words, due to an increased amount of carbon particles within the spray droplets, the evaporation rate of the organic solvents may become non-uniform, making the formation of a hollow structure challenging. Additionally, as the proportion of carbon becomes higher than that of nano-silicon, the proportion of the active material in the electrode may decrease, thereby reducing battery capacity.

Furthermore, when the spherical powders are present in an amount of 6 parts by weight or more, the proportion of the aqueous carbon solution decreases, thereby increasing the viscosity of the second spray solution. As a result, nozzle clogging may occur when spraying the second spray solution, and a uniform distribution of the spray droplets may fail to be achieved.

In the second drying step (S40), a spherical powder composite having a hollow structure may be obtained by spraying the second spray solution and performing drying.

In this case, the second spray solution may further include the aforementioned mixed solvent or organic solvents. Accordingly, after spraying the second spray solution, the organic solvent evaporates, thereby allowing uniform coating and fixation of carbon on the spherical powders, that is, formation of a carbon layer that surrounds the spherical powders.

In the heat treatment step (S50), that is, a step to stabilize the aforementioned carbon layer, the spherical powder composite is subjected to heat treatment in an inert atmosphere.

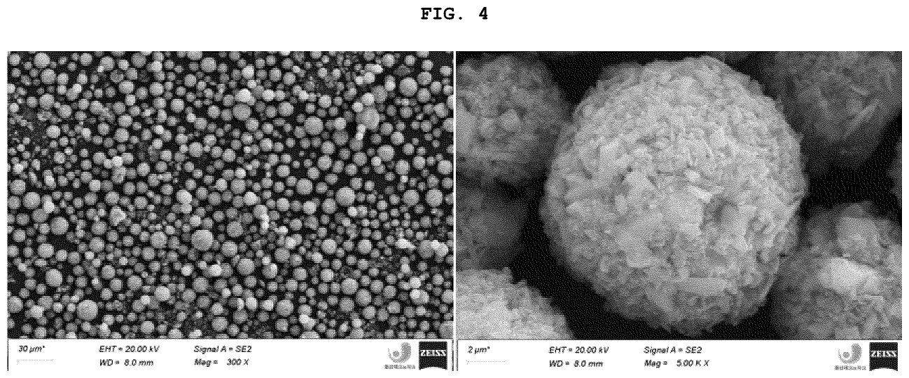

In other words, in the heat treatment step (S50), the bonding strength with the spherical powders may be increased, so expansion of the spherical powders may be suppressed. Accordingly, referring to FIG. 4, the heat-treated silicon-carbon composite negative electrode material, obtained through heat treatment, can be confirmed.

Specifically, in the heat treatment step (S50), heat treatment may be performed at a temperature in the range of 600° C. to 800° C. in an inert atmosphere for 2 to 4 hours.

In other words, when performing heat treatment at a temperature in the range of 600° C. to 800° C., the remaining organic components, including the binder polymer and the organic solvents, may be effectively carbonized, and a conductive carbon layer may be formed.

In this case, at a temperature of 600° C. or lower, the organic components may not be carbonized, thereby forming a non-uniform carbon layer. In contrast, at a temperature of 800° C. or higher, mass loss may occur due to thermal degradation.

Additionally, when performing heat treatment for 2 hours or less, carbonization may be incomplete, thereby forming a non-uniform carbon layer. In contrast, when performing heat treatment for 4 hours or more, strength may decrease due to thermal degradation.

As described above, the prepared spherical powder composite is formed to have a small size of 10 μm or less, thereby enabling suppression of cracking of the spherical silicon particles under low mechanical stress during volume expansion, and thus high exhibiting cycle efficiency. Additionally, by forming a uniform conductive network and optimizing electron transport pathways during charging and discharging, fast charging may be enabled. Furthermore, by obtaining a uniform particle morphology with high sphericity, the stability of the composite paste during a rolling process, which is essential in a secondary battery manufacturing process, may be improved, thereby ensuring uniformity in electrode formation.

In the meantime, the present disclosure aims to provide a silicon-carbon composite negative electrode material prepared by the aforementioned method of preparing a silicon-carbon composite negative electrode material.

Additionally, the silicon-carbon composite negative electrode material provided by the present disclosure may have an average particle diameter in the range of 5 to 20 μm. The average particle diameter may be 7 μm or more or 9 μm or more, and 18 μm or less, 16 μm or less, or 14 μm or less. However, the present disclosure is not limited thereto. When the silicon-carbon composite negative electrode material has an average particle diameter within the above range, uniform dispersion of particles within an electrode may be promoted. Furthermore, charging and discharging efficiency, as well as cycle life, of the silicon-based negative electrode material may be improved.

In the meantime, the present disclosure may provide a secondary battery including the silicon-carbon composite negative electrode material prepared as described above. This battery can significantly increase the driving range of vehicles, reduce charging time, and extend battery lifetime.

The advantages and characteristics of the present disclosure and methods for achieving those will become clear with reference to the following embodiments described in detail in conjunction with the attached drawings. However, the present disclosure is not limited to the embodiments set forth below and will be implemented in many different forms. The following embodiments are provided only to completely disclose the present disclosure and inform those skilled in the art to which the present disclosure pertains of the scope of the present disclosure. The present disclosure is defined only by the scope of the appended claims. Like reference numerals are used throughout the specification to indicate like components.

Hereinafter, the present disclosure will be described with reference to drawings for explaining a method of preparing a silicon-carbon composite negative electrode material according to embodiments of the present disclosure.

### Example 1

First, silicon having a diameter of 1 μm was ball-milled or jet-milled to a diameter of 0.3 μm.

Subsequently, ethanol and NMP were mixed at a 4:1 mass ratio to prepare a mixed solvent. Then, 3 wt % of a binder polymer was added to the mixed solvent and stirred. Subsequently, 5 wt % of nano-silicon was added to the mixed solvent and stirred to prepare a first spray solution.

Then, the prepared first spray solution was spray-dried to obtain spherical powders having a hollow structure in which silicon nanoparticles were agglomerated. Thereafter, 5 wt % of the obtained spherical powders were added to 1 wt % of an aqueous graphene solution, followed by stirring to prepare a second spray solution.

The prepared second spray solution was spray-dried to obtain a spherical powder composite having a hollow structure.

The spherical powder composite was then subjected to heat treatment at 700° C. in an inert atmosphere for 3 hours.

As described above, a silicon-carbon composite negative electrode material was prepared.

It was confirmed that the finally prepared silicon-carbon composite negative electrode material had a hollow structure, and the surface thereof was coated with an electrode active material (commercially available carbon). The average particle diameter was measured to be in the range of approximately 8 to 12 μm.

### Comparative Example 1

In Comparative Example 1, a negative electrode material was prepared in the same manner as in Example 1, except that the first spray solution was prepared using ethanol alone without NMP, instead of the mixed solvent.

### Comparative Example 2

In Comparative Example 2, a negative electrode material was prepared in the same manner as in Example 1, except that the first spray solution was prepared using water, instead of the mixed solvent or organic solvents (ethanol and NMP).

### Comparative Example 3

In Comparative Example 3, a negative electrode material was prepared by performing heat treatment on the spherical powder having a hollow structure obtained from the first spray solution of Example 1 (without preparing and spray-drying the second spray solution as in Example 1).

### Comparative Example 4

In Comparative Example 4, a negative electrode material was prepared by obtaining the spherical powder composite having a hollow structure from the second spray solution of Example 1 (without involving heat treatment as in Example 1).

### Comparative Example 5

In Comparative Example 5, a negative electrode material was prepared in the same manner as in Example 1, except that silicon having a diameter of 1 μm was used to prepare the spherical powder composite.

### Evaluation Example

The composite negative electrode material of Example 1 or each of the negative electrode materials of Comparative Examples 1 to 5 was appropriately mixed with spherical graphite for a negative electrode material. Thereafter, an aqueous slurry was prepared by mixing an appropriate amount of water, a binder (styrene-methyl acrylate copolymer/carboxylated butadiene rubber (SMC/CBR) or polyacrylic acid (PAA)), and a conductive additive (carbon black such as Super P), followed by coating of a copper plate with the slurry. Then, a firmly adhered coating of the slurry on the copper plate was achieved through heat treatment, and the resulting product was punched to manufacture a circular negative electrode plate. Additionally, a lithium chip was prepared as a positive electrode plate. A polyethylene (PE) separator, a spacer, a coin-cell container, a spring, and a gasket were prepared and assembled to manufacture a coin cell. The manufactured coin cells were evaluated under charging/discharging conditions of 0.1 C/0.1 C at 25° C., and charge storage capacity (mAh/g) and cycle efficiency (at 200 cycles, %) were measured. The results thereof are shown in Table 1.

The experimental results of charge storage capacity and cycle efficiency for Example 1 and Comparative Examples 1 to 5 are shown in [Table 1] below.

TABLE 1

| | | Comparative | Comparative | Comparative | Comparative | Comparative |
|---|---|---|---|---|---|---|
| | Example 1 | Example 1 | Example 2 | Example 3 | Example 4 | Example 5 |
| Charge storage | 2,018 | 1,975 | 1,889 | 1,482 | 1,763 | 2,162 |
| capacity (mAh/g) | | | | | | |
| Cycle efficiency | 90 | 82 | 80 | 81 | 79 | 75 |
| (at 200 cycles, %) | | | | | | |

The silicon-graphene composite negative electrode material according to Example 1 was confirmed to exhibit superior charge storage capacity and cycle efficiency compared to the negative electrode materials of Comparative Examples 1 to 5.

Specifically, compared to Example 1, Comparative Example 1, in which the negative electrode material was prepared using only ethanol without NMP, showed that both charge storage capacity and cycle efficiency tended to decrease. This is presumed to be due to difficulty in achieving uniform dispersion of the electrode active material when using a single solvent (ethanol) alone rather than a mixed solvent. This is because, in a mixed solvent system, uniform distribution of the active material and formation of a uniform coating layer are possible by utilizing the characteristics of each solvent, whereas, when using a single solvent (ethanol) alone, silicon and carbon may fail to be uniformly dispersed, resulting in agglomeration and reduced structural stability of the electrode, which is problematic.

Additionally, Comparative Example 2, in which the negative electrode material was prepared using water rather than the mixed solvent or organic solvents (ethanol and NMP), showed that the conductivity within the electrode tended to decrease, and the internal resistance within the electrode tended to increase. This is presumed to be because, compared to organic solvents, water as a solvent interacts differently with the electrode active material, making uniform distribution within the electrode challenging and preventing formation of a uniform coating layer. As a result, electron transport during charging and discharging is hindered, thereby increasing the reaction resistance and leading to the presumption that both charge storage capacity and cycle efficiency decrease.

Comparative Example 3, in which the negative electrode material was prepared by performing heat treatment on the spherical powders having a hollow structure, obtained without preparing and spray-drying the second spray solution, showed that, compared to Example 1, the charge storage capacity tended to decrease significantly (1,482 mAh/g). This is presumed to be because the omission of the processes of preparing and spray-drying the second spray solution causes non-uniform distribution of silicon and carbon, resulting in a decrease in the uniformity of the electrode coating layer. When the coating layer is non-uniform, electron transport pathways are unevenly formed, resulting in localized increases in resistance during charging and discharging, which may degrade the electrochemical performance of the electrode.

Comparative Example 4, in which the negative electrode material was prepared without involving the heat treatment, confirmed that, compared to Example 1, both the charge storage capacity and cycle efficiency were reduced. This is presumed to be because organic components, including the remaining binder polymer and organic solvents, failed to be effectively carbonized due to the omission of the heat treatment process, thereby preventing complete formation of a conductive carbon coating layer. When such a carbon coating layer is incomplete, connectivity between the electrode active material and the conductive network weakens, and gradual detachment of the active material may occur during charging and discharging, resulting in reduced structural stability of the electrode.

Comparative Example 5, in which the negative electrode material was prepared using micro-silicon having a diameter of 1 μm instead of nano-silicon, showed that, although the initial charge storage capacity increased slightly, long-term cycle efficiency tended to decrease significantly. This is presumed to be because, as the size of micro-silicon particles becomes larger, volume expansion becomes more severe during charging and discharging, resulting in reduced mechanical stability of the electrode. In particular, repeated charging and discharging cause rapid cracking of silicon particles, leading to disconnection of the conductive network within the electrode and promoting delamination of the electrode active material. As a result of the analysis, the long-term cycle efficiency decreases significantly.

Accordingly, it can be confirmed that the composite negative electrode material prepared by the preparation method of the present disclosure exhibits excellent performance in terms of both charge storage capacity and cycle efficiency, leading to an expectation that this composite negative electrode material has high potential for use as a next-generation negative electrode material in the future EV battery market.

Those skilled in the art to which the present disclosure pertains will appreciate that the present disclosure may be embodied in other specific forms without departing from the technical idea or essential features thereof. Therefore, it should be understood that the embodiments described hereinabove are illustrative in all respects and not restrictive. The scope of the present disclosure is defined by the appended claims rather than the detailed description presented above. All changes or modifications derived from the meaning and scope of the claims and the concept of equivalents should be construed as falling within the scope of the present disclosure. Additionally, the order of operation of the components described in the foregoing processes does not necessarily need to be performed in a chronological sequence. Even when the order of execution of the respective components and steps is changed, it is apparent that such processes may fall within the scope of the present disclosure, provided that the gist of the present disclosure is satisfied.

What is claimed is:

1. A method of preparing a silicon-carbon composite negative electrode material, the method comprising:
preparing a first spray solution by adding a binder polymer and nano-silicon to a mixed solvent comprising two or more organic solvents and stirring the resulting mixture;
spraying the first spray solution and performing first drying to obtain spherical powders having a hollow structure in which nano-silicon particles are agglomerated;
preparing a second spray solution by stirring the spherical powders with a commercially available carbon source;
spraying the second spray solution and performing second drying to obtain a spherical powder composite having a hollow structure; and
performing heat treatment on the spherical powder composite in an inert atmosphere,
wherein the mixed solvent comprises:
a first organic solvent comprising one or more of N-methyl-2-pyrrolidone (NMP), dimethyl sulfoxide (DMSO), dimethylformamide (DMF), and tetrahydrofuran (THF); and
a second organic solvent comprising one or more of ethanol, methanol, and acetic acid, and
the first and second organic solvents in the mixed solvent are mixed at a mass ratio in a range of 10:1 to 2:1.

2. The method of claim 1, wherein the preparing of the first spray solution comprises:
preparing the mixed solvent comprising the two or more organic solvents;
adding the nano-silicon to the mixed solvent and performing first stirring; and
adding the binder polymer after the first stirring and performing second stirring.

3. The method of claim 1, wherein the mixed solvent comprises:
the first organic solvent having a first boiling point; and
the second organic solvent having a second boiling point lower than the first boiling point.

4. The method of claim 1, wherein the binder polymer is present in an amount in a range of 1 to 5 parts by weight with respect to 100 parts by weight of the mixed solvent.

5. The method of claim 1, wherein the nano-silicon is present in an amount in a range of 1 to 7 parts by weight with respect to 100 parts by weight of the mixed solvent.

6. The method of claim 1, wherein the nano-silicon has a size in a range of 0.1 to 0.7 μm.

7. The method of claim 1, wherein the commercially available carbon source comprises one or more of natural graphite, artificial graphite, carbon black, acetylene black, graphite intercalated compounds (GICs), expanded graphite, activated carbon, graphite nanoplatelets (GNPs), and carbon nanotubes (CNTs).

8. The method of claim 1, wherein the commercially available carbon source is an aqueous carbon solution comprising one or more carbon materials,
100 parts by weight of the aqueous carbon solution contain 0.5 to 1.5 parts by weight of the one or more carbon materials, and
the spherical powders are present in an amount in a range of 4 to 6 parts by weight with respect to 100 parts by weight of the aqueous carbon solution.

9. The method of claim 1, wherein the heat treatment is performed at a temperature in a range of 600° C. to 800° C. in an inert atmosphere for 2 to 4 hours.

10. A silicon-carbon composite negative electrode material prepared by the method of claim 1.

11. A secondary battery comprising:
the silicon-carbon composite negative electrode material of claim 10.

12. The method of claim 2, wherein the mixed solvent comprises:
the first organic solvent having a first boiling point; and
the second organic solvent having a second boiling point lower than the first boiling point.

13. The method of claim 2, wherein the binder polymer is present in an amount in a range of 1 to 5 parts by weight with respect to 100 parts by weight of the mixed solvent.

14. The method of claim 2, wherein the nano-silicon is present in an amount in a range of 1 to 7 parts by weight with respect to 100 parts by weight of the mixed solvent.
